(19) United States
(12) Patent Application Publication
(10) Pub. No.: US 2008/0107944 A1
(43) Pub. Date: May 8, 2008

(54) Folded edge seal for reduced cost fuel cell

(75) Inventor: Steven G. Goebel, Victor, NY (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM Global Technology Operations, Inc., Detroit, MI (US)

(21) Appl. No.: 11/592,939

(22) Filed: Nov. 3, 2006

(51) Int. Cl. H01M 8/02

(52) U.S. Cl. 429/26; 429/35

(57) ABSTRACT

A technique for sealing the edges of fuel cells in a fuel cell stack that employs folding over the edge of bipolar plates. For those bipolar plates include both an anode side uni-polar plate and a cathode side uni-polar plate, one or both of the edges of the uni-polar plates can be folded. The folds can be provided to accommodate a tunnel between a flow header and flow channels in the active area, where the anode uni-polar plate is typically folded for the anode flow headers and the cathode uni-polar plate is typically folded for the cathode flow headers.

### BACKGROUND OF THE INVENTION

1. Field of the Invention

This invention relates generally to a sealing technique for a fuel cell stack and, more particularly, to a sealing technique for a fuel cell stack that includes folding the edges of the bipolar plates between the fuel cells.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

Various techniques are known in the art for fabricating the bipolar plates. In one design, the bipolar plates are made of a composite material, such as graphite, where two plate halves are separately molded and then glued together so that anode flow channels are provided at one side of one of the plate halves, cathode flow channels are provided at an opposite side of the other plate half and cooling fluid flow channels are provided between the plate halves. In another design, two separate plate halves are stamped and then welded together so that anode flow channels are provided at one side of one of the plate halves, cathode flow channels are provided at an opposite side of the other plate half and cooling fluid flow channels are provided between the plate halves.

As is well understood in the art, the membranes within a fuel cell need to have a certain relative humidity so that the ionic resistance across the membrane is low enough to effectively conduct protons. During operation of the fuel cell, moisture from the MEAs and external humidification may enter the anode and cathode flow channels. At low cell power demands, typically below 0.2 A/cm², the water may accumulate within the flow channels because the flow rate of the reactant gas is too low to force the water out of the channels. As the water accumulates, it forms droplets that continue to expand because of the relatively hydrophobic nature of the plate material. The droplets form in the flow channels substantially perpendicular to the flow of the reactant gas. As the size of the droplets increases, the flow channel is closed off, and the reactant gas is diverted to other flow channels because the channels are in parallel between common inlet and outlet manifolds. Because the reactant gas may not flow through a channel that is blocked with water, the reactant gas cannot force the water out of the channel. Those areas of the membrane that do not receive reactant gas as a result of the channel being blocked will not generate electricity, thus resulting in a non-homogenous current distribution and reducing the overall efficiency of the fuel cell. As more and more flow channels are blocked by water, the electricity produced by the fuel cell decreases, where a cell voltage potential less than 200 mV is considered a cell failure. Because the fuel cells are electrically coupled in series, if one of the fuel cells stops performing, the entire fuel cell stack may stop performing.

A fuel cell stack typically includes a seal that extends around the active area of the fuel cells between the stack headers and the active area for each fuel cell to prevent gas leakage from the stack. Therefore, in order to get the cathode flow, the anode flow and the cooling fluid flow from the respective inlet header into the active area of the fuel cell, it is necessary for the flow channels to go through the seal area without affecting seal integrity. Typically holes or tunnels are provided through the bipolar plate around the seals, which requires a bend in the flow channels so that they line up with the flow channels in the active area. This bend in the cathode and anode flow channels provided an area that water could accumulate and be trapped which had a tendency to close the flow channel and reduce the flow of reactant gas thereto. Therefore, a better technique for traversing the seal area of the fuel cell stack is needed.

### SUMMARY OF THE INVENTION

In accordance with the teachings of the present invention, a technique for sealing the edges of fuel cells in a fuel cell stack is disclosed that employs folding over the edge of bipolar plates. In one embodiment, the bipolar plates include an anode side uni-polar plate and a cathode side uni-polar plate, where the anode side uni-polar plate defines anode flow channels and the cathode side uni-polar plate defines cathode flow channels. Cooling fluid flow channels are provided between uni-polar plates. Depending on whether the seal is at an edge of the active area of the fuel cell, or between a reactant gas header or a cooling fluid header and the active area of the fuel cell, various designs can be employed for folding the edge of the uni-polar plates to provide the seal. In one design, both of the uni-polar plate edges are folded. In an alternate design, only one of the uni-polar plates is folded. Additionally, one of the uni-polar plates can be folded in a double fold configuration. Also, the folds can be provided to accommodate a tunnel between a header and flow channels in the active area. In another embodiment, the bipolar plate is a single plate that does not include cooling fluid flow channels. Various designs can also be provided for the folded edge of the single plate bipolar plate in the same or similar manner.

Additional features of the present invention will become apparent from the following description and appended claims, taken in conjunction with the accompanying drawings.

### BRIEF DESCRIPTION OF THE DRAWINGS

FIG. 1 is a top plan view of a fuel cell stack including stamped bipolar plates having folded edge seals, according to another embodiment of the present invention;

FIG. 2 is a top plan view of a cathode plate for the fuel cell stack shown in FIG. 1;

FIG. 3 is a top plan view of an anode plate for the fuel cell stack shown in FIG. 1;

FIGS. 4(a)-4(d) are top plan views of a bipolar plate for the fuel cell stack shown in FIG. 1 showing a technique for folding the edges of the plate over to provide a seal for a corrugated plate, according to the invention;

FIG. 5 is a cross-sectional view of a bipolar plate and surrounding fuel cell structure in the fuel cell stack shown in FIG. 1 through line 5-5 where both the anode and cathode plates have folded edges, according to an embodiment of the present invention;

FIG. 6 is a cross-sectional view of a bipolar plate and surrounding fuel cell structure in the fuel cell stack shown in FIG. 1 through line 5-5 where the anode flow plate has a folded edge, according to another embodiment of the present invention;

FIG. 7 is a cross-sectional view of a bipolar plate and surrounding fuel cell structure in the fuel cell stack shown in FIG. 1 through line 5-5 where both the anode flow plate and the cathode flow plate have folded edges and where the cathode plate includes a second fold and an extended section, according to another embodiment of the present invention;

FIG. 8 is a cross-sectional view of a bipolar plate and surrounding fuel cell structure in the fuel cell stack shown in FIG. 1 through line 8-8 where both the anode and cathode flow plates have folded edges, according to an embodiment of the present invention;

FIG. 9 is a cross-sectional view of a bipolar plate and surrounding fuel cell structure in the fuel cell stack shown in FIG. 1 through line 9-9 where the anode and cathode flow plates have a folded edge, according to an embodiment of the present invention;

FIG. 10 is a cross-sectional view of a bipolar plate and surrounding fuel cell structure in the fuel cell stack shown in FIG. 1 through line 10-10 where both the anode and cathode flow plates have folded edges, according to an embodiment of the present invention;

FIG. 11 is a cross-sectional view of a bipolar plate and surrounding fuel cell structure in the fuel cell stack shown in FIG. 1 through line 8-8 where the cathode flow plate has a folded edge, according to another embodiment of the present invention;

FIG. 12 is a cross-sectional view of a bipolar plate and surrounding fuel cell structure in the fuel cell stack shown in FIG. 1 through line 9-9 where the anode flow plate has a folded edge, according to another embodiment of the present invention;

FIG. 13 is a cross-sectional view of a bipolar plate and surrounding fuel cell structure in the fuel cell stack shown in FIG. 1 through line 10-10 where the anode flow plate has a folded edge, according to another embodiment of the present invention;

FIG. 14 is a cross-sectional view of a bipolar plate and surrounding fuel cell structure for a corrugated cathode in the fuel cell stack shown in FIG. 1 through line 8-8 where the cathode flow plate has a folded edge, according to another embodiment of the present invention;

FIG. 15 is a cross-sectional view of a bipolar plate and surrounding fuel cell structure for a corrugated cathode in the fuel cell stack shown in FIG. 1 through line 9-9 where the anode flow plate has a folded edge, according to another embodiment of the present invention;

FIG. 16 is a cross-sectional view of a bipolar plate and surrounding fuel cell structure for a corrugated cathode in the fuel cell stack shown in FIG. 1 through line 10-10 where the anode flow plate has a folded edge, according to another embodiment of the present invention;

FIG. 17 is a broken-away plan view of a portion of the fuel cell stack shown in FIG. 1 depicting a corner between a cathode header and a cooling fluid header, according to another embodiment of the present invention;

FIG. 18 is a cross-sectional view of a bipolar plate and surrounding fuel cell structure in the fuel cell stack shown in FIG. 17 through line 18-18 where the anode and cathode flow plates have a folded edge, according to an embodiment of the present invention;

FIG. 19 is a cross-sectional view of a bipolar plate and surrounding fuel cell structure in the fuel cell stack shown in FIG. 17 through line 18-18 where the anode and cathode flow plates have a folded edge, according to another embodiment of the present invention;

FIG. 20 is a top plan view of a fuel cell stack that employs a single bipolar plate design, according to another embodiment of the present invention;

FIG. 21 is a plan view of a portion of the fuel cell stack shown in FIG. 20 depicting a cathode and anode flow field layout, according to another embodiment of the present invention;

FIG. 22 is a plan view of a portion of the fuel cell stack shown in FIG. 20 depicting a cathode and anode flow field layout with interferences removed, according to another embodiment of the present invention;

FIG. 23 is a plan view of a portion of the fuel cell stack shown in FIG. 20 depicting a cathode and anode flow field layout including lands, according to another embodiment of the present invention;

FIG. 24 is a plan view of a portion of the fuel cell stack shown in FIG. 20 depicting a cathode and anode flow field layout including arbitrary branching, according to another embodiment of the present invention;

FIG. 25 is a cross-sectional view of a bipolar plate and surrounding fuel cell structure of the fuel cell stack shown in FIG. 20 through line 25-25 having filled diffusion media layers, according to another embodiment of the present invention;

FIG. 26 is a cross-sectional view of a bipolar plate and surrounding fuel cell structure of the fuel cell stack shown in FIG. 20 through line 25-25 including two seals, according to another embodiment of the present invention;

FIG. 27 is a cross-sectional view of a bipolar plate and surrounding fuel cell structure of the fuel cell stack shown in FIG. 20 through line 25-25 including a folded edge and a filled diffusion media layer, according to another embodiment of the present invention;

FIG. 28 is a cross-sectional view of a bipolar plate and surrounding fuel cell structure of the fuel cell stack shown in FIG. 20 through line 25-25 having a folded edge, according to another embodiment of the present invention;

FIG. 29 is a cross-sectional view of a bipolar plate and surrounding fuel cell structure of the fuel cell stack shown in FIG. 20 through line 25-25 including a double folded edge, according to another embodiment of the present invention;

FIG. 30 is a cross-sectional view of a bipolar plate and surrounding fuel cell structure of the fuel cell stack shown in FIG. 20 through line 30-30 including filled diffusion media layers, according to another embodiment of the present invention;

FIG. 31 is a cross-sectional view of a bipolar plate and surrounding fuel cell structure of the fuel cell stack shown in FIG. 20 through line 30-30 including shims and seals, according to another embodiment of the present invention;

FIG. 32 is a cross-sectional view of a bipolar plate and surrounding fuel cell structure of the fuel cell stack shown in FIG. 20 through line 30-30 including folded edge and a filled diffusion media layer, according to another embodiment of the present invention;

FIG. 33 is a cross-sectional view of a bipolar plate and surrounding fuel cell structure of the fuel cell stack shown in FIG. 20 through line 33-33 including a folded edge and filled diffusion media layer, according to another embodiment of the present invention;

FIG. 34 is a cross-sectional view of a bipolar plate and surrounding fuel cell structure of the fuel cell stack shown in FIG. 20 through line 30-30 including a folded edge and shims, according to another embodiment of the present invention;

FIG. 35 is a cross-sectional view of a bipolar plate and surrounding fuel cell structure of the fuel cell stack shown in FIG. 20 through line 33-33 including a folded edge and shims, according to another embodiment of the present invention;

FIG. 36 is a cross-sectional view of a bipolar plate and surrounding fuel cell structure of the fuel cell stack shown in FIG. 20 through line 33-33 including a folded edge with holes and filled diffusion media layer, according to another embodiment of the present invention;

FIG. 37 is a cross-sectional view of a bipolar plate and surrounding fuel cell structure of the fuel cell stack shown in FIG. 20 through line 33-33 including a folded edge with holes and shims, according to another embodiment of the present invention;

FIG. 38 is a cross-sectional view of a bipolar plate and surrounding fuel cell structure of the fuel cell stack shown in FIG. 20 through line 30-30 including a folded edge and a thick shim, according to another embodiment of the present invention;

FIG. 39 is a broken-away plan view of a portion of the fuel cell stack shown in FIG. 20 depicting a corner between a cathode header and an anode header, according to another embodiment of the present invention;

FIG. 40 is a cross-sectional view of a bipolar plate and surrounding fuel cell structure of the fuel cell stack shown in FIG. 39 through line 40-40 including a folded edge and a thick shim, according to another embodiment of the present invention;

FIG. 41 is a top plan view of a fuel cell stack including water atomization, according to another embodiment of the present invention; and

FIG. 42 is a cross-sectional view of a plurality of fuel cells in the fuel cell stack shown in FIG. 41 including staggered seals and inserts, according to another embodiment of the present invention.

### DETAILED DESCRIPTION OF THE EMBODIMENTS

The following discussion of the embodiments of the invention directed to a fuel cell stack that includes bipolar plates having folded edges to provide a seal is merely exemplary in nature, and is in no way intended to limit the invention or applications or uses.

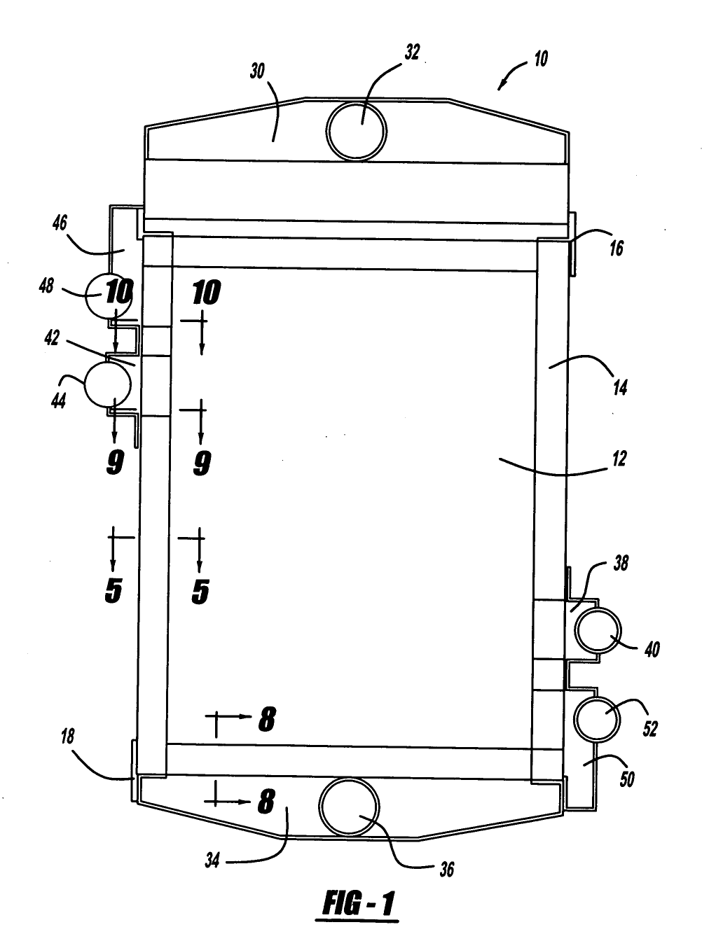

FIG. 1 is a top plan view of a fuel cell stack 10 including a stack active area 12. The fuel cell stack 10 includes bipolar plates having anode and cathode side stamped uni-polar plates. A suitable seal 14 is provided around the active area 12 and can take on various configurations according to the invention, as will be discussed in detail below. Corner covers 16 and 18 are provided at diagonal corners of the active area 12 to provide sealing at the corners of the active area 12. Cathode inlet air flows to a cathode inlet header 30 through a pipe 32 and a cathode exhaust gas is output from the stack 10 through a cathode exhaust gas header 34 and a pipe 36. Hydrogen gas flows into an anode inlet header 38 through a pipe 40 and an anode exhaust gas is output from the stack 10 through an anode exhaust gas header 42 and a pipe 44. The stack cooling fluid enters the stack 10 through a cooling fluid inlet header 46 by a pipe 48, and exits the stack 10 through a cooling fluid outlet header 50 by a pipe 52. The headers 46 and 50 are sealed to the side of the stack 12 and stack end plates, and seal the corners.

According to the invention, the edges of the uni-polar plates have a folded edge design to create an elastic response for plate to membrane and plate-to-plate sealing. The main motivation for this concept, as with the stamped bead seal known to those skilled in the art, is the significant cost reduction by the elimination of elastomer seals for each fuel cell. The folded edge design provides additional cost reduction by the elimination of the laser welding and the slot cutting needed for current stamped plate designs. This design provides straight through tunnels, which should improve water management and freeze start as water has been seen to accumulate in the tunnels of known stamped plate designs. For hydrophilically treated tunnels, the coating does not need to be applied internally so this design is amenable to line-of-sight coating processes. A straight cathode flow path may permit plate forming by corrugation to achieve finer pitches, and therefore higher current density. The stacking could be done with cells split at the cooling fluid layer because the uni-plates do not have to be joined. This may allow stacking to be done in a non-clean room facility as the soft goods (membrane and diffusion media) would be protected by the two uni-plates with the plates included in the unitized assembly. The folded edge design does require the use of external headers and adhesive fillers to join the external headers to the rough sides of the stack 10. External headers should reduce the amount of metal required to fabricate the plates and could facilitate the integration of a water vapor transfer unit.

By folding the edges of the plates, a joint is formed at each corner of the active area 12. These joints create a potential leak path and the direction of the fold determines which fluid, reactant gas or cooling fluid, could leak from such a joint. The folds also create a by-pass channel around the active area 12, so it is preferred that the folds contain the cooling fluid. A film material could be inserted into the fold to reduce the by-pass. In one configuration, the cooling fluid headers 46 and 50 cover the corners to contain the joints and prevent cooling fluid from leaking overboard. For the corners without a header, the covers 16 and 18 are used to prevent leaks. The upper and lower surfaces of the plates are smooth for sealing to the membrane, or sub-gasket, and the joint only appears to the cooling fluid. To minimize the number of joints, the headers can be aligned with a rectangular plate layout.

For the external headers 30, 34, 38, 42, 46 and 50, it is expected that a relatively thick application of sealant or adhesive, such as RTV, can be used to seal where the external header flanges traverse the relatively bumpy stack outer faces. The flanges on the cathode headers 30 and 34 are internal on the sides to prepare a generally flat sealing surface for the cooling fluid header flanges and the covers 16 and 18. Internal flanges on all of the headers 30, 34, 38,42, 46 and 50 may be preferred to maximize the header area per footprint.

Selection of header location and plate aspect ratio affect flow distribution and pressure drop. The “Z” type layout where the anode and cooling fluid headers 38, 42, 46 and 50 are in the same side, as shown in FIG. 1, has been found to have better cooling fluid distribution than a co-flow layout, with anode and cooling fluid headers 38, 42, 46 and 50 on opposite sides, from CFD evaluations as the cross-flow channels are better balanced from end-to-end. For one nested plate design, arrangement with inherently higher active area cooling fluid pressure drops and non-active feeder regions with gaps, the cooling fluid distribution would be less sensitive to feed region channel patterns. To minimize the non-active feed region size, the anode and cooling fluid flow channels could have greater branching ratios, which could increase anode and coolant pressure drops. A more narrow plate aspect ratio would also decrease the fraction of the feed region, but would increase all active area pressure drops. The sizes of headers and seals would also need to be taken into consideration in design evaluations considering stack size and pressure drop.

FIG. 2 is a top plan view of a cathode side uni-polar plate 60 in an un-folded condition for the fuel cell stack 10 indicating locations for folds 62 at each end, according to an embodiment of the present invention. A microseal 64 is formed around a perimeter of the plate 60. The cathode flow channels would be nested in a central region 66 where feed regions 68 and 70 are provided at each end.

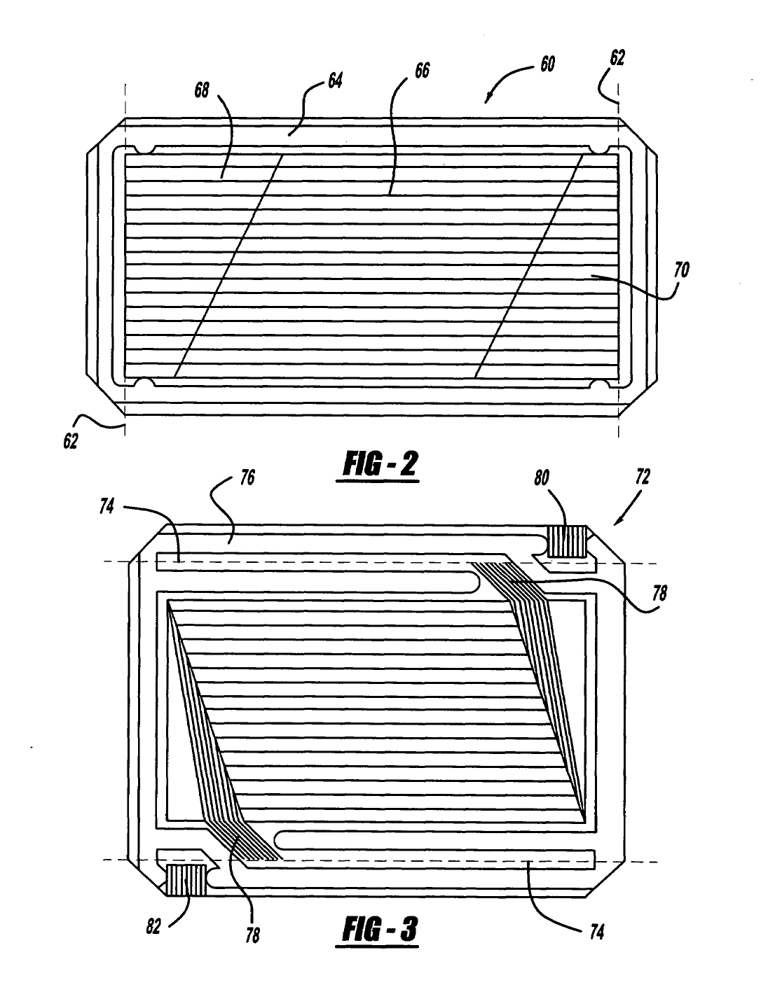

FIG. 3 is a top plan view of an anode side uni-polar plate 72 in an un-folded condition for the fuel cell stack 10 indicating locations for folded edges 74 at each side, according to an embodiment of the present invention. A microseal 76 is formed around the edge of the plate 72. Anode flow tunnels 78 are provided at ends of the plate 72, and cooling fluid tunnels 80 and 82 would flow under the plate 72.

The straight cathode flow channels may permit plate forming by corrugation to achieve finer pitches and higher current densities. In this case, wiggles could not be used, but at a very fine pitch, the channel spans may be short enough to prevent diffusion media layer scissoring, such that wiggles are not required. This forming method would also create the corrugated pattern across the sealing surface to be folded under. This pattern could be removed from this region by using rollers of progressive steps, if necessary. Folding the re-smooth plate edge would subsequently form the edge seal.

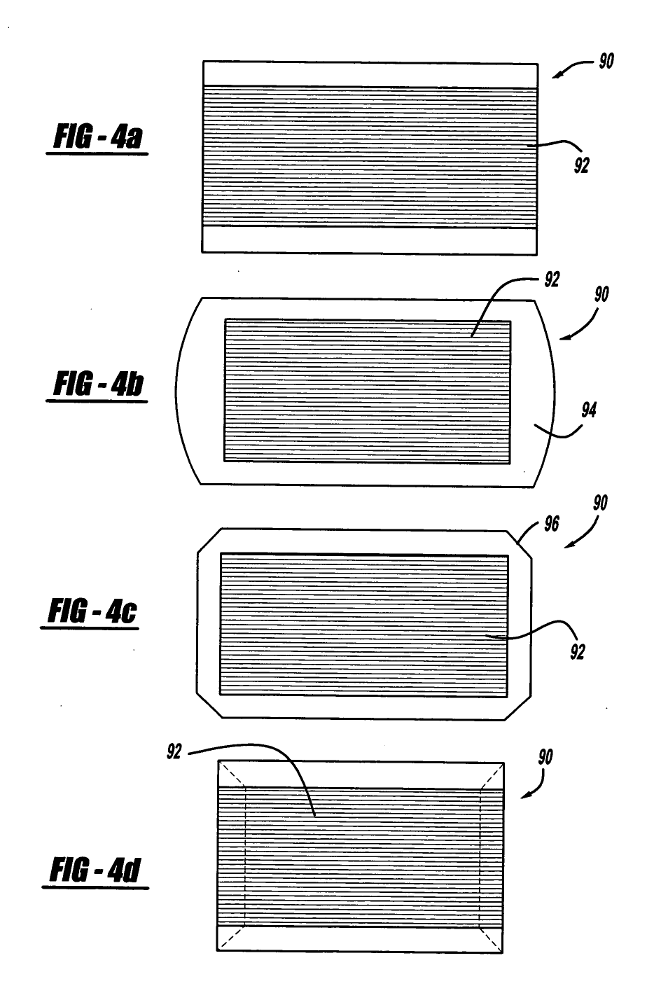

Such a process is illustrated in FIGS. 4(a)-4(d) showing corrugated plate forming steps, according to the invention. Particularly, a corrugated uni-polar plate 90 is shown in FIG. 4(a) having straight flow channels 92 that extend end-to-end of the plate 90. The corrugation is then removed from the ends 94 of the plate 90 to provide a smooth end surface so that excess material may flow out, as shown in FIG. 4(b). The plate 92 is then cut to shape, as shown in FIG. 4(c), to provide a beveled cut corner 96 to avoid an interference of the folds. The ends 94 are then folded under to provide a seal under the tunnels, as shown in FIG. 4(d).

The pipes 32, 36, 40, 44, 48, 52 are shown perpendicular to the cells from the “wet” end as in conventional stacks. With the use of external headers, other plumbing orientations are possible. A feed and exhaust orientation parallel to the cells could be used. Such a parallel configuration could minimize cell-to-cell flow mal-distribution as orientation of the proximal-to-distal end of the header over which pressure variations may occur is along the cell and not across multiple cells. Thus, in the parallel configuration, flow mal-distributions are more likely to occur within a cell. While uniform flow to all cells and within each cell is desired, due to the serial nature of the stack 10, achieving the same flow to all cells is more critical. External headers would also facilitate the integration of a water vapor transfer unit.

The active area 12 is surrounded by a perimeter consisting of edges and tunnels. At the edges, a seal must be formed between a plate, or its functional expansion, and the membrane, or its functional extension, on both faces. At the tunnels, only one face of the membrane must seal to the plate while the other side is open to allow reactant gas from the respective header to pass to the desired side of the membrane. To achieve sealing, a smooth, continuous surface must be provided on both faces. These surfaces also need to support a compressive load for sealing while also providing compliance to absorb thickness variations. Folded plate edges are considered to achieve the required thickness in these regions and provide sealing compliance.

Shims could be used to provide a smooth surface and carry seal loads over tunnels. However, the termination of a shim creates a step. Having a continuous shim around the perimeter of the active area 12 eliminates the step, but requires a large additional part. This functionality could be achieved by using a thick sub-gasket. Two sub-gaskets may be needed to prevent ionomer to plate contact, unless thrifted membranes are used. One of these sub-gaskets could be thicker to function as a shim over the tunnels. The window of this thicker sub-gasket could be larger than the diffusion media layer to avoid excess compression that could occur if the thick sub-gasket was located under the diffusion media layer, as is typically done with sub-gaskets. The thinner sub-gasket could end up under the diffusion media layer to define the electrode overlap.

FIG. 5 is a cross-sectional view through line 5-5 of a bipolar plate 102 and the surrounding fuel cell structure 100 in the fuel cell stack 10. The bipolar plate 102 includes a stamped metal cathode side uni-polar flow plate 104 and a stamped metal anode side uni-polar flow plate 106. The metal will typically be stainless steel. A cathode side diffusion media layer 108 is provided adjacent to the cathode side plate 104 and an anode side diffusion media layer 110 is provided adjacent to the anode side plate 106. A cell membrane 112 for one fuel cell is positioned adjacent to the diffusion media layer 108 opposite to the plate 104, and a cell membrane 114 for another fuel cell is provided adjacent to the diffusion media layer 110 and opposite to the anode side flow plate 106. Cathode flow channels 116 are provided by the cathode side plate 104 and anode flow channels 118 are provided by the anode side plate 106. Cooling fluid flow channels 120 are provided between the plates 104 and 106.

According to the invention, in this embodiment the cathode plate 104 includes a folded end portion 124 and the anode flow plate 106 includes a folded end portion 126 that define the seal at the seal area 14. In this design, the tunnels for the flow channels can be formed through either plate 104 or 106. However, the space for the folded portions 124 and 126 is limited, especially for a nested channel active area. Shims 128 and 130 are provided on opposite sides of the membrane 112 at the seal area 14 and shims 132 and 134 are provided on opposite sides of the membrane 114 at the seal area 14 to complete the cell thickness.

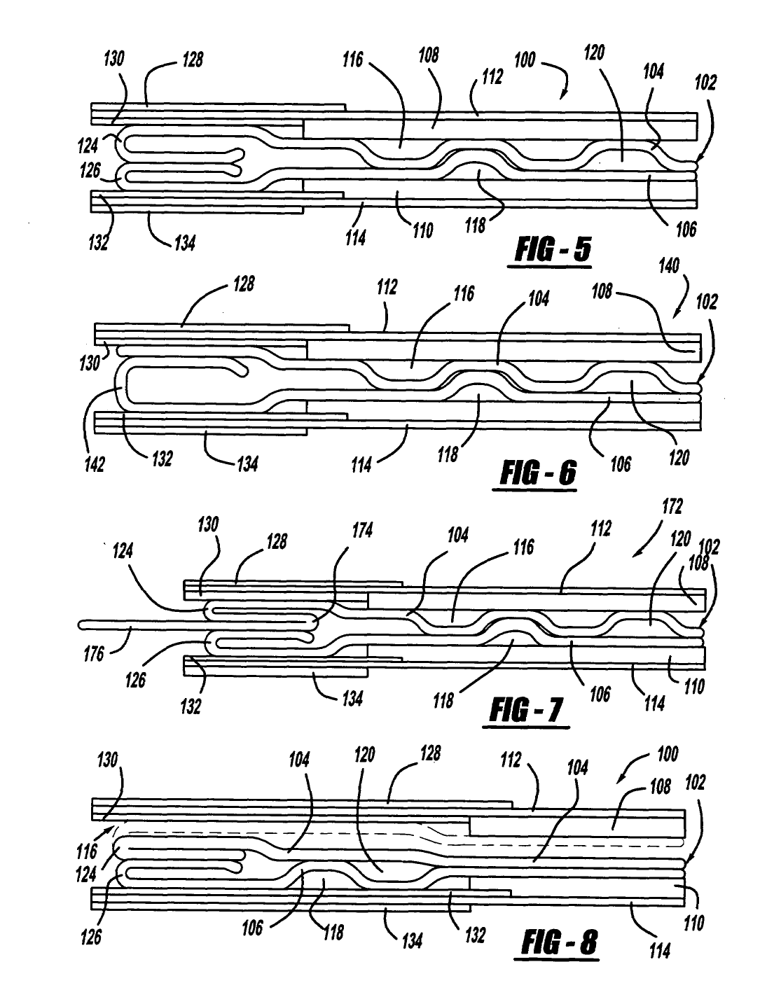

FIG. 6 is a cross-sectional view of a fuel cell structure 140 for another seal design at the seal area 14 through line 5-5 of the stack 10, according to another embodiment of the present invention, where like elements to the structure 100 are identified by the same reference numeral. In this design, the cathode plate 104 does not include the folded end portion 124. However, the anode flow plate 106 includes a larger folded end portion 142 that provides the seal and allows for more space for the fold. In an alternate embodiment, the cathode plate 104 could be folded, and the anode plate could be straight at the seal area 14.

To accommodate cell voltage tabs, cell-to-cell shorting strips and alignment pins, the plate edges can be extended. This is not an issue for the edge folded configuration of the fuel cell structure 140, as the non-folded plate edge can be extended to accommodate these features. With both edges folded, one plate could be folded a second time to allow extension of this plate to accommodate these features. However, this configuration provides even less room for the folds. The additional folds could also be useful for cooling fluid by-pass blockage. Otherwise, a foam insert or fill could be provided.

To illustrate this design, FIG. 7 is a cross-sectional view of a fuel cell structure 172 through line 5-5, according to another embodiment of the present invention, where like elements to the fuel cell structure 100 are identified by the same reference numeral. In this embodiment, the cathode plate 104 includes a second folded region 174, and an extended plate 176 that provides the tab.

The sealing method used at the edges needs to be consistent with the configuration at the tunnels. This provides limited space for the folds and tunnels. The folds on each plate 104 and 106 continue to the corners, which are covered by the cooling fluid headers 46 and 50. The configuration for only one plate edge folded is generally preferred as it allows more space for the folds and tunnels. This also requires fewer plate folds. For tunnel support, the use of a thick sub-gasket is generally preferred. This has the added benefit of providing membrane support over the feed region of a nested plate configuration without the use of an additional shim.

Tunnel configurations can be provided where both of the flow plates 104 and 106 are folded, which provides limited space for the folds and the tunnels. FIG. 8 is a cross-sectional view of the fuel cell structure 100 through line 8-8 in FIG. 1 showing both the cathode flow plate 104 and the anode flow plate 106 having the folded edge portions 124 and 126, respectively, and showing the tunnel for the cathode flow channels 116 through the seal area 14 to the cathode outlet header 34.

FIG. 9 is a cross-sectional view of the fuel cell structure 100 through line 9-9 in FIG. 1 showing both the cathode flow plate 104 and the anode flow plate 106 having the folded edge portions 124 and 126, respectively, and showing the tunnel for the anode flow channels 118 through the seal area 14 to the anode outlet header 42.

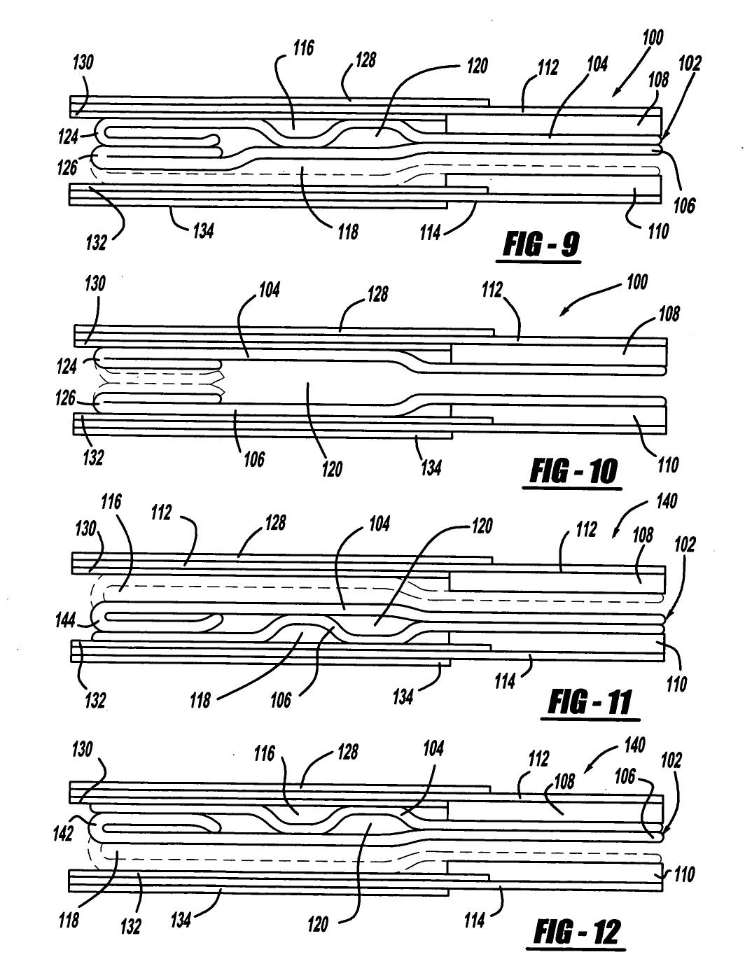

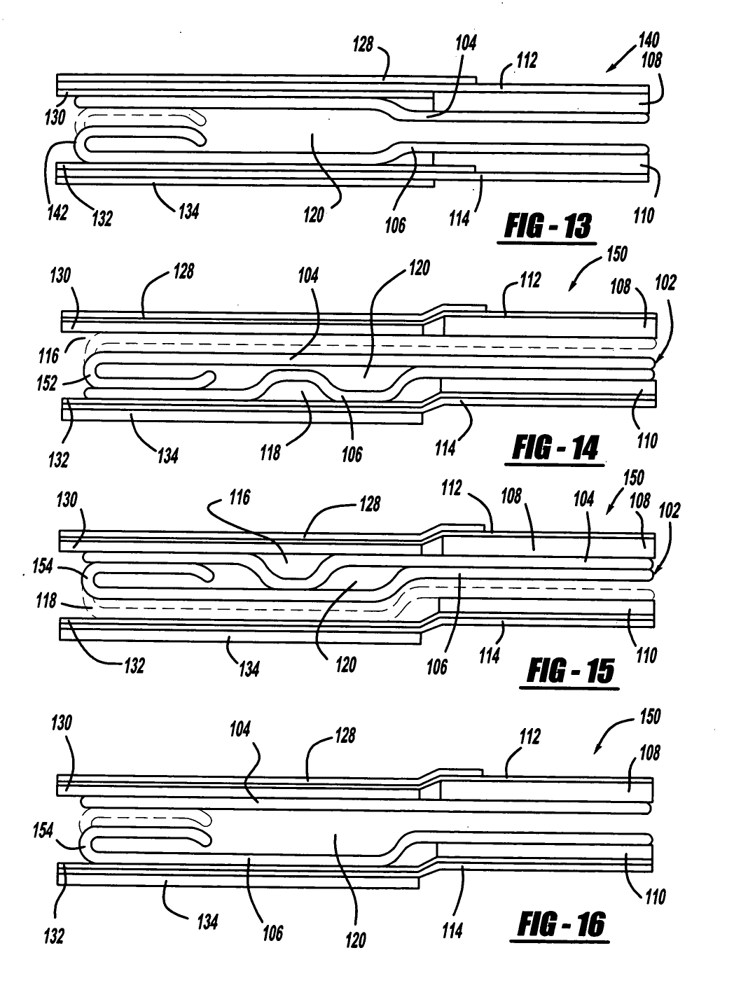

FIG. 10 is a cross-sectional view of the fuel cell structure 100 through line 10-10 in FIG. 1 showing both the cathode flow plate 104 and the anode flow plate 106 having the folded edge portions 124 and 126, respectively, and showing the tunnel through the sealing area 14 for the cooling fluid flow channels 120 to the cooling fluid inlet header 46.

Tunnel configurations can be provided where only one of the flow plates 104 and 106 is folded, which provides more space for the folds and the tunnels. On the plate edges with the anode headers 38 and 42, the anode plate 106 is folded. On the plate edges with the cathode headers 30 and 34, the cathode plate 104 is folded. FIG. 11 is a cross-sectional view of the fuel cell structure 140 through line 8-8 in FIG. 1 showing the cathode flow plate 104 having a folded edge portion 144, where the anode flow plate 106 is straight, and showing the tunnel for the cathode flow channels 116 through the seal area 14 to the cathode outlet header 34.

FIG. 12 is a cross-sectional view of the fuel cell structure 140 through line 9-9 in FIG. 1 showing the anode flow plate 106 having the folded edge portion 142, where the cathode flow plate 104 is straight, and showing the tunnel for the anode flow channels 118 through the seal area 14 to the anode outlet header 42.

FIG. 13 is a cross-sectional view of the fuel cell structure 140 through line 10-10 in FIG. 1 showing the anode flow plate 106 having the folded edge portion 142, where the cathode flow plate 104 is straight, and showing the tunnel for the cooling fluid flow channels 120 through the seal area 14 to the cooling fluid inlet header 46.

Tunnel configurations for a cathode plate formed by corrugation are shown by a fuel cell structure 150 in FIGS. 14-16, according to another embodiment of the present invention, where like elements are identified by the same reference numeral. FIG. 14 is a cross-sectional view of the fuel cell structure 150 through line 8-8 in FIG. 1 showing the cathode flow plate 104 having a folded edge portion 152, where the anode flow plate 106 is straight, and showing the tunnel for the cathode flow channels 116 through the seal area 14 to the cathode outlet header 34.

FIG. 15 is a cross-sectional view of the fuel cell structure 150 through line 9-9 in FIG. 1 showing the anode flow plate 106 having a folded edge portion 154, where the cathode flow plate 104 is straight, and showing the tunnel for the anode flow channels 118 through the seal area 14 to the anode outlet header 42.

FIG. 16 is a cross-sectional view of the fuel cell structure 150 through line 10-10 in FIG. 1 showing the anode flow plate 106 having the folded edge portion 154, where the cathode flow plate 104 is straight, and showing the tunnel for the cooling fluid flow channels 120 through the seal area 14 to the cooling fluid inlet header 46.

For the cathode plate corrugation method, the cathode surface does not have a step. The need for a step is unique to the nested plate configuration without the diffusion media layers in the feed region, which is preferred for volumetric power density. In the fuel cell structures 100 and 140, this step was split between the anode and cathode plates 104 and 106. For the corrugated cathode plate, this step cannot be accommodated by the corrugation process, so the entire step height appears in the anode plate 106. Note that the tunnel section views are along a channel to illustrate this feature.

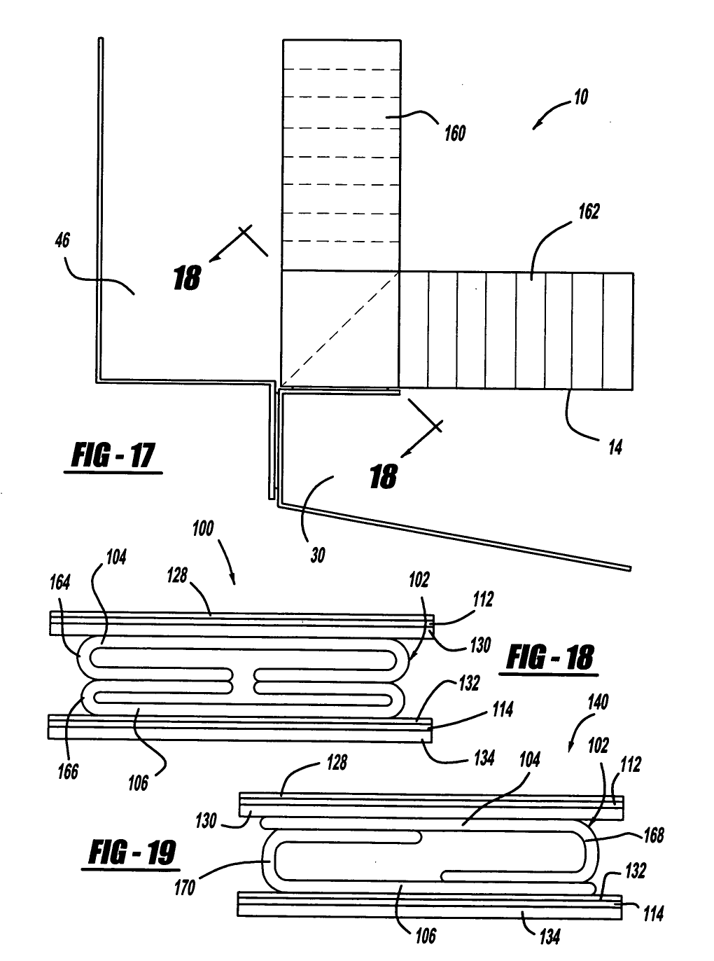

FIG. 17 is a plan view of a corner portion of the fuel cell stack 10 at which the cooling fluid inlet header 46 and the cathode inlet header 30 meet. Cooling fluid flow tunnels 160 are shown through the seal area 14 adjacent to the cooling fluid inlet header 46 and cathode inlet flow tunnels 162 are shown through the seal area 14 adjacent to the cathode inlet header 30.

FIG. 18 is a cross-sectional view of the fuel cell structure 100 through line 18-18 in FIG. 17 where both the cathode flow plate 104 and the anode flow plate 106 include folded edge portions 164 and 166, respectively, at the seal area 14.

FIG. 19 is a cross-sectional view of the fuel cell structure 140 through line 18-18 in FIG. 17 where the cathode flow plate 104 includes a folded edge portion 168 and the anode flow plate 106 includes a folded edge portion 170.

It has been proposed in the art to employ a bipolar plate design that is stamped from a single thickness of sheet metal, such as stainless steel, and provides the cathode flow channels and the anode flow channels, particularly for molten carbonate fuel cells where cooling is not required. U.S. Pat. No. 6,960,404 issued Nov. 1, 2005 to Goebel, assigned to the Assignee of this application and herein incorporated by reference, discloses evaporative cooling of a PEM fuel cell such that a single thickness of stamped sheet metal could be used for a bipolar plate.

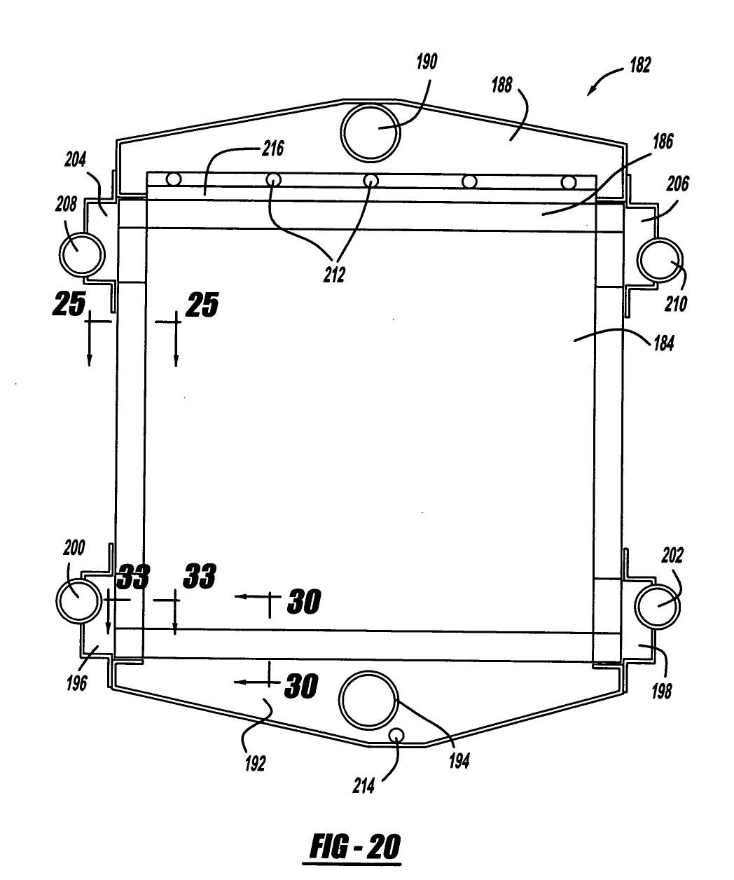

FIG. 20 is a top plan view of a fuel cell stack 182 including a representative design of a stack including such bipolar plates, according to an embodiment of the present invention. The stack 182 includes an active area 184 having a perimeter edge sealing area 186. Cathode inlet air is introduced into a cathode inlet header 188 through a pipe 190, and exits the stack 182 through a cathode exhaust gas header 192 and a pipe 194. Hydrogen gas is introduced into dual anode inlet headers 196 and 198 through pipes 200 and 202, respectively, and the anode exhaust gas is output from the stack 182 through dual anode exhaust gas headers 204 and 206 and pipes 208 and 210, respectively. The stack 182 is cooled by evaporative cooling, and employs drip tubes 212 and a drain tube 214. By using evaporative cooling, the requirement for cooling fluid passages separate from the reactant gas flow between the uni-polar plates is eliminated. The motivation for this concept is the cost reduction that is provided with only a single sheet of metal and the elimination of plate joining processes. Additional components required for an evaporative cooling system that are not shown include a condenser and separator or water supply, pumps and a filter.

The evaporative cooling water is introduced into the cathode inlet header 188 and wets the cathode side of the bipolar plates. The plates have a hydrophilic coating to ensure imbibing of the water into, across and along the plate. From visual observations of plate wetting, water appears to move about 2 cm/s with an average film thickness of about 20 μm based on how far a metered amount of water spreads. This water movement would provide a water delivery rate of about 4 μL/s/cm². The heat of evaporation of the water at 2.4 J/mg is about 9.6 W/cm², which is well in excess of the full power heat removal from the stack 182 of about 0.94 W/cm². The total water flow requirement at full stack power (103 kW of heat) is about 43 g/s. Tests specifically directed towards evaluating water spreading rates and the impact of wetting distance can be used to evaluate the feasibility and guide the design of this concept. Excessive evaporative cooling water is removed from the cathode exhaust header 192.

With only a single sheet of metal for the bipolar plates, it is difficult to form the needed thickness for header loops for sealing without resorting to costly elastomer seals to provide thickness in these regions. Therefore, external headers are used that further reduce the amount of metal required to fabricate the bipolar plates. It will become apparent from the discussion below that the corners create some unique joint challenges that can be addressed by applying one of the headers across the joint.

The stack 182 includes a number of desirable features, including two sets of anode inlet and outlet headers, counter-flow anode gas, wide aspect ratio, feed and exhaust plumbing direction, anode headers over corners, rather than the cathode headers, use of heated drip tubes and hydrophilic foam for evaporative cooling water introduction and removal.

Where the cathode and anode flow fields are aligned, the corrugations of the stamped plate provide unrestricted flow passages for both anode and cathode flow channels, such as upward corrugations providing cathode flow channels and downward corrugations providing anode flow channels. However, where the reactant gases must diverge to different headers, the desired flow directions create a conflict, which is addressed by using half height channels where necessary. These half height channels induce an increased pressure drop. To minimize the size of the cross flow regions, the two sets of the anode inlet and outlet headers 196, 198, 204 and 206 are used. Because the anode inlet and outlet headers 196, 198, 204 and 206 are on the same sides of the bipolar plate, there is a longer flow path to, along and from the center-line of the bipolar plate. To balance the flow paths, the number of cross-flow field channels per longitudinal channel is adjusted. An alternative would be to have the entire flow field and cross-flow with the anode inlet header across one edge and the anode outlet header across the other edge. This would have a bump and dimple flow field and effectively half-height channels everywhere, which would lead to higher-pressure drops for both the flow fields.

The anode flow is counter to the cathode flow and was selected to minimize the amount of water leaving the anode flow channels, which should be less than the conventionally cooled stack as the temperature gradient is much larger, i.e., colder at the cathode inlet. However, it would be prudent to evaluate both counter-flow and co-flow configurations, and the flow paths are symmetric to allow such evaluation. The anode side of the bipolar plates can have a hydrophilic coating to provide the known benefits, such as better flow uniformity without slugs of water.

The wide aspect ratio was selected to minimize the required wetting distances and cathode pressure drop. Wetting tests and design calculations can be used to determine the allowable dimensions and expected pressure drops.

In one embodiment, the anode and cathode feed and exhaust channels are perpendicular to the fuel cells from the “wet” end, as is conventional. This orientation was selected to minimize interference with the header sealing flanges. With the use of external headers, other plumbing orientations are possible, as will be appreciated by those skilled in the art. It is expected that the face of the cathode headers 188 and 192 would be approximately square, so there is not a preferred direction. A feed and exhaust orientation parallel to the fuel cells can be used. Such a parallel configuration could minimize cell-to-cell flow mal-distribution as orientation of the proximal-to-distal end of the header over which pressure variations may occur is along the fuel cell, and not across multiple cells. Thus, in this parallel configuration, flow mal-distributions are more likely to occur within the cell. While uniform flow to all cells and within each cell is directed, due to the parallel nature of the stack 182, achieving the same flow to all cells is more important.

The anode headers 196, 198, 204 and 206 cover the corners of the active area 184. In one configuration, where the plate edges are folded over to form a spring seal, one of the reactant gas channels occupies the void formed by the spring seal. All edges must be folded in the same direction so that reactant gases do not mix. Further, the edges cannot be folded around the corner, so this creates a joint where leaks could occur. By covering the joint with an external header, the leaks are contained. While it would be preferred to minimize the anode volume, an over-riding requirement is to maintain a continuous surface across the cathode for wetting. To meet this requirement, the bipolar plate fold is such that this void contains the anode gas flow. Note that the flanges on the cathode headers 188 and 192 are internal on the side towards the joining anode headers to provide a generally flat sealing surface for the anode header flanges. It is expected that a relatively thick application of sealant or adhesive, such as RTV, can be used to seal the external headers, especially where the external header flanges traverse the relatively bumpy cell edges.

The evaporative cooling water is supplied and removed by the heated drip and drain tubes, 212 and 214, respectively. Multiple drip tubes 212 are shown, and each tube 212 is expected to have multiple openings for discharging water uniformly over the cathode inlet header 188. To further distribute the water, hydrophilic foam 216 covers the inlet face of the cathode inlet header 188. Additional features may be used to enhance the dripping or removal of excessive evaporative cooling water from the plate. The cathode exhaust gas header 192 is tapered to direct the excess water to the drain tube 214. All of the tubes 212 and 214 would include some form of heating to facilitate initiation and sustaining operation under freeze conditions. The heating may be in the form of an electrically heated and insulated wire within the tubes 212 and 214. Catalyzing the foam 216 and using the hydrogen bleed could be used to assist frozen starts and cold operation.

The supply of water for the evaporative cooling can be obtained by condensing and separating water from the cathode exhaust gas to maintain water neutrality. A water buffer within the system can be used to allow extended operation under conditions of high heat load. Water can also be supplied to the vehicle, such as during hydrogen fill ups. The maximum required water is about 20 kg per small kg of hydrogen. The cooling water could also be acquired by the combination of condensing and refilling.

A pump is required to remove water from the cathode exhaust gas header 192. Depending on the methods of water supply, a pump would also be used to move water from the separator or the water supply tank to the cathode inlet header.

As water evaporates, dissolved solids would be deposited if the concentration exceeds the solubility. To alleviate this potential issue, a chemical filter can be used in the evaporative cooling water loop. Further, a continual flow of evaporative water promotes removal of any dissolved materials from the stack. If a water supply is used, this water should be of high purity. It should be noted that such deposits may be more likely to occur within conventional cells where water from relatively wet regions will carry dissolved solids from the plate and move to drier regions of the cell, and fully evaporate thereby continually depositing any dissolved solids within these drier regions.

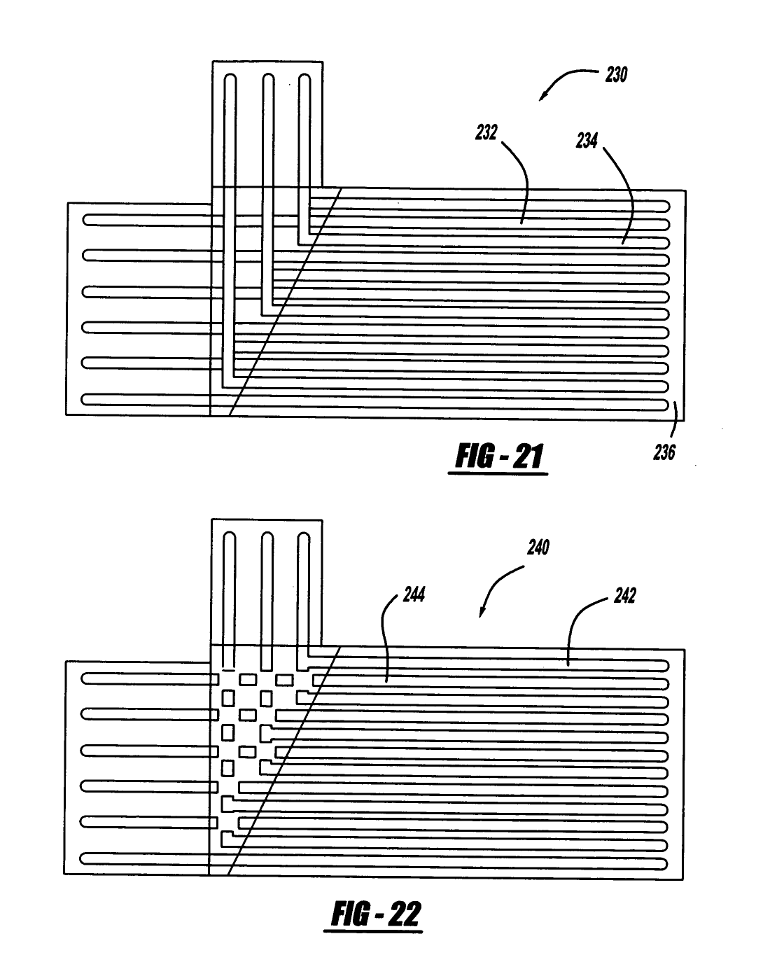

The anode and cathode flow fields were generated by considering the desired channel patterns for the cathode and the anode gases. FIG. 21 is a plan view of a corner area of a fuel cell stack 230 showing cathode and anode flow channels 232 and 234 in an active area 236, according to an embodiment of the present invention. Lands are not shown as in some sense each reactant gas flow field would desire the entire flow area without any lands. Of course, lands are necessary to support the gap between the channels and the diffusion media layer, and also to provide an electrical and thermal conductive path. These lands will appear where the alternate flow field requires channels or no channel is required.

Where both flow fields require a channel, the plate elevation is maintained at the nominal value. FIG. 22 is a plan view of a corner area of a fuel cell stack 240 including anode flow channels 242 and cathode flow channels 244 showing this design. If desired, the nominal elevation can be biased towards the anode or cathode to affect relative pressure drops and flow distribution.

Where neither flow field requires channels, such as in the tunnels, lands can be added. FIG. 23 is a plan view of a corner area of a fuel cell stack 250 including anode flow channels 252 and cathode flow channels 254 showing this design. Lands 256 are also added between anode cross-channels to reduce interaction between the feed channels to better allow tailoring of the anode flow balance.

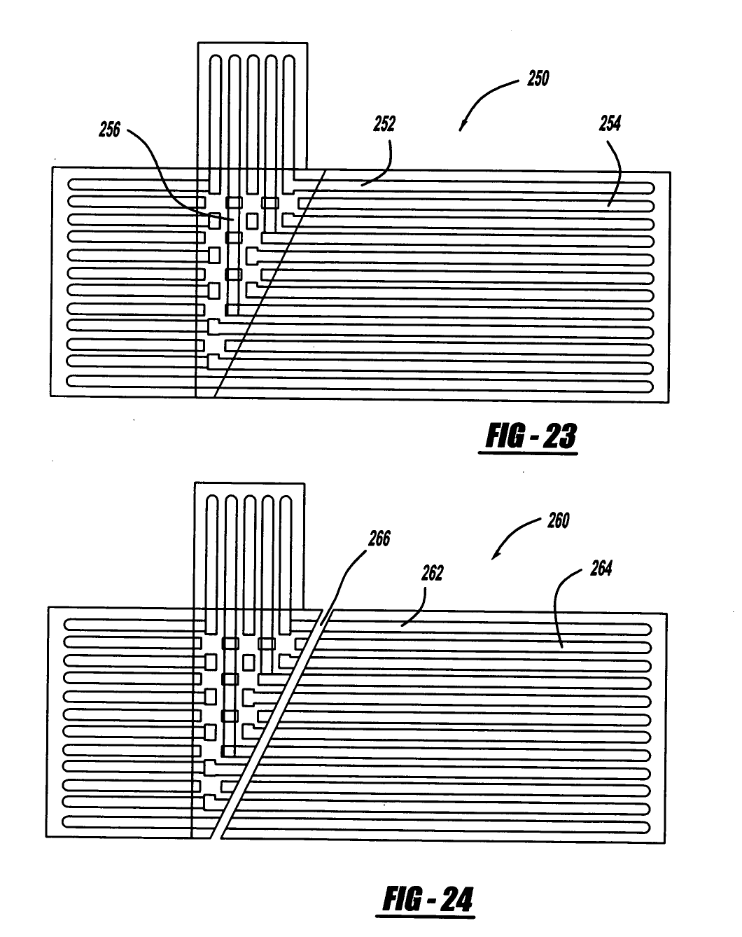

Due to the highly three-dimensional forming of the anode and cathode cross-flow region, a more coarse pitch could be used in this region without restriction to a finer pitch that could be used in the aligned region, which only has two dimensional forming by the inclusion of an open space between these regions to allow arbitrary flow branching between any feed to adjacent channels in the aligned region. FIG. 24 is a plan view of a corner area of a fuel cell stack 260 including anode flow channels 262 and cathode flow channels 264 showing this design, where an open space 266 for arbitrary branching is provided.

For the flow fields shown in FIGS. 21-24, wiggles are not shown simply for ease of understanding. The configuration shown in FIG. 24 may allow an alternate fabrication method to achieve finer pitches. The aligned channels could be formed by corrugations. In this case, wiggles would not be used, but at a very fine pitch, the channel spans may be short enough to prevent diffusion media layer scissoring, such that wiggles are not required. Such forming would also create the corrugated pattern in the cross-channel and cathode tunnel regions. This pattern could be removed from these regions by using rollers of progressive steps if necessary. The desired pattern could then be formed by stamping cross-channels, cathode tunnels and anode tunnel regions only. The edge features would subsequently be formed by folding.

For the end cells, no special treatment is required other than to block reactant flow to the non-used side of the last plate. This is an advantage over conventionally cooled cells where it is desirable to reduce the cooling fluid flow to the end cell to match the heat load, which requires a special end plate design.

The active area 184 is surrounded by a perimeter consisting of edges and tunnels. For this single plate design, the corners present unique challenges. At the edges, a seal must be formed between the plate, or its functional extension, and the membrane on both faces. At the tunnels, only one face of the membrane must seal to the plate while the other face is open to allow reactant gas flow from the respective header to pass to the desired side of the membrane. To achieve sealing, a smooth, continuous surface should be provided on both faces. These surfaces also need to support a compressive load for sealing, while also providing compliance to absorb thickness variations. Within the active area, the repeat thickness equals the MEA thickness, both compressed diffusion media layer thicknesses, the channel depth plus the plate thickness. The compressed perimeter thickness must match the active area repeat thickness. Approaches to this end are to use an elastomer seal, to stamp the plate to the desired thickness and fill the recesses with an elastomer or cover with a shim to provide a smooth surface, extend the diffusion media layer into the perimeter, and to fold the plate edge back upon itself to create thickness and a spring like seal.

An elastomer seal is expensive relative to desired fuel cell costs, and filling plate features with elastomer thickness would also be expensive. Shims can be used to provide a smooth surface and carrying sealing loads especially over tunnels. However, the termination of the shim creates a step. Having a continuous shim around the perimeter eliminates the step, but requires a large additional part. This functionality could be achieved by using a thick sub-gasket. Diffusion media layers extended into these regions would need to be filled to allow sealing. Another approach to prevent leakage out of the diffusion media layers, which is extended to the perimeter, is to wrap the sub-gasket around the diffusion media layer edge. With two sub-gaskets, this method can be applied to both diffusion media layers. However, this approach presents some issues at the corners where joints are formed. The folded plate approach is attractive as no additional parts are required and the compliance accommodates thickness variations.

The conventional seal and tunnel method used for stamped plates will not work for a single plate. This method can be employed by adding a second layer of stamped plates for the tunnels. The second layer would need to be sealed to the primary plate, such as by laser welding. The second layer would also create a step equal to the metal thickness that the seal must traverse unless the second layer was as large as the primary plate, which obviously defeats the purpose of the single plate. Alternately, two inserts covering only the tunnel regions could be used. Because the steps and holes needed in these alternative designs are also prohibitive for water filming, the need for additional plates, the need for a weld and a costly elastomer seal, this approach has certain drawbacks.

FIG. 25 is a cross-sectional view of a fuel cell structure 270 in the stack 182 through line 25-25, according to an embodiment of the present invention. The structure 270 includes a single sheet bipolar plate 272 of the type discussed above. A cathode side diffusion media layer 274 is positioned on one side of the plate 272 and an anode side diffusion media layer 276 is positioned on an opposite side of the plate 272. A cell membrane 278 is positioned adjacent to the diffusion media layer 274 opposite to the plate 272 and a cell membrane 280 is positioned adjacent to the diffusion media layer 276 opposite to the plate 272. The plate 272 and the diffusion media layer 274 define cathode reactant gas flow channels 282 and the plate 272 and the diffusion media layer 276 define anode reactant gas flow channels 284. In this embodiment for the seal area 186, a suitable elastomer fill 286 is provided around the plate 272, and a fill material 288 and 290 are provided in combination with the diffusion media layers 274 and 276, respectively, as shown.

Plate forming is used to define the desired thickness, which is subsequently filled to create smooth surfaces. To stay within the bounds of material stretch by stamping, the formed thickness is the same as the flow field. The diffusion media layers 274 and 276 are extended on both surfaces to fill the remaining space, and the diffusion media layer edges are filled. This approach may be as costly as an elastomer seal due to the process time for the fill material to cure. It may be desirable for the material cure to occur after the stack 182 is assembled to allow the fill material 288 and 290 to conform to thickness variations.

FIG. 26 is a cross-sectional view of a fuel cell structure 300 in the fuel cell stack 182 through line 25-25 for a different sealing design, where like elements to the fuel cell structure 270 are identified by the same reference numeral, according to another embodiment of the present invention. In this embodiment, the plate 272 includes a flat portion 306 at the seal area 186. An elastomer seal 302 is provided between the flat portion 306 and the membrane 278 and an elastomer seal 304 is provided between the flat portion 306 and the membrane 280 to provide the seal. This embodiment allows one of the seals to be removed in the tunnel regions to allow reactant gas flow to the paths.

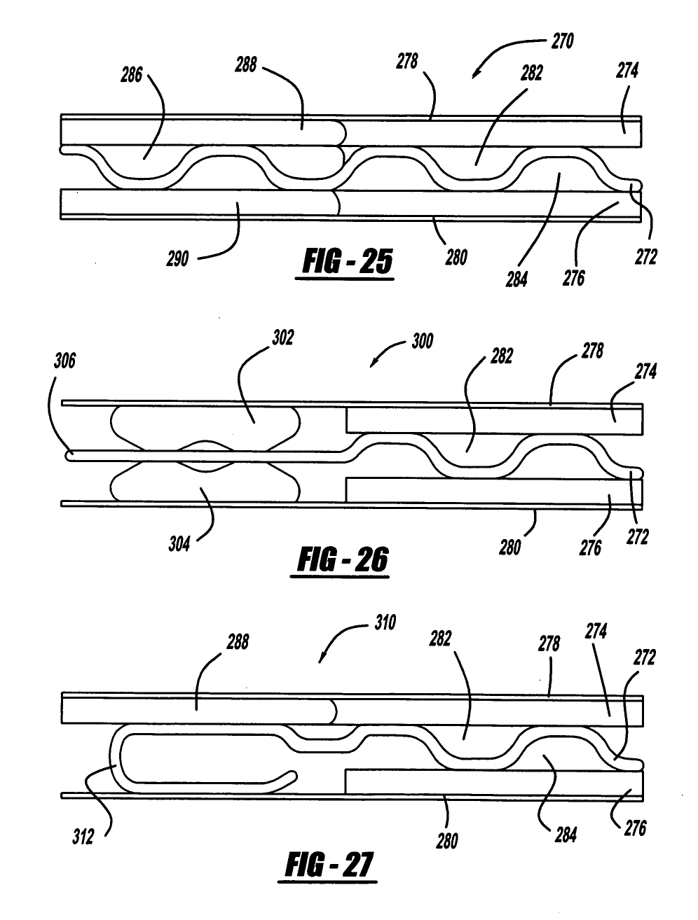

FIG. 27 is a cross-sectional view of a fuel cell structure 310 in the fuel cell stack 182 through line 25-25 for a different sealing design, where like elements to the fuel cell structure 270 are identified by the same reference numeral, according to another embodiment of the present invention. In this embodiment, the plate 272 includes a folded edge portion 312 at the seal area 186 that fills the space between the fill material 288 and the membrane 280, as shown. The filled diffusion media layer 274 may extend into the edges as shown as a continuation of a smooth compression carrying surfaces needed for tunnels.

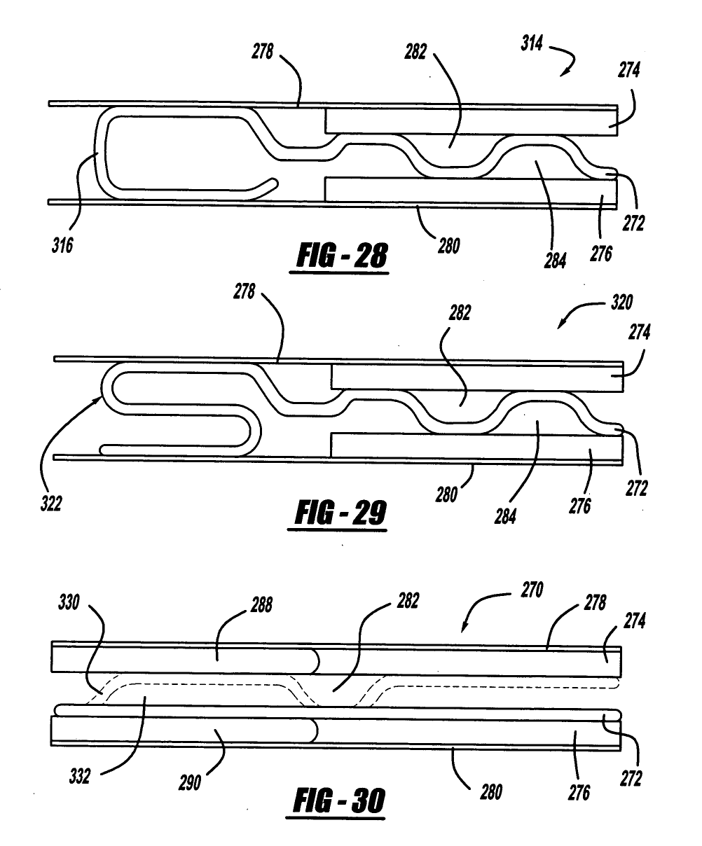

FIG. 28 is a cross-sectional view of a fuel cell structure 314 in the fuel cell stack 182 through line 25-25 for a different sealing design, where like elements to the fuel cell structure 270 are identified by the same reference numeral, according to another embodiment of the present invention. In this embodiment, the diffusion media layers 274 and 276 have been shortened, and an edge of the plate 272 has been folded over to provide a folded edge portion 316 that provides the seal at the seal area 186. A configuration with a folded edge where both the diffusion media layers 274 and 276 extend into the edge is possible, but the space left for the folded edge may be too small, especially in the tunnel regions.

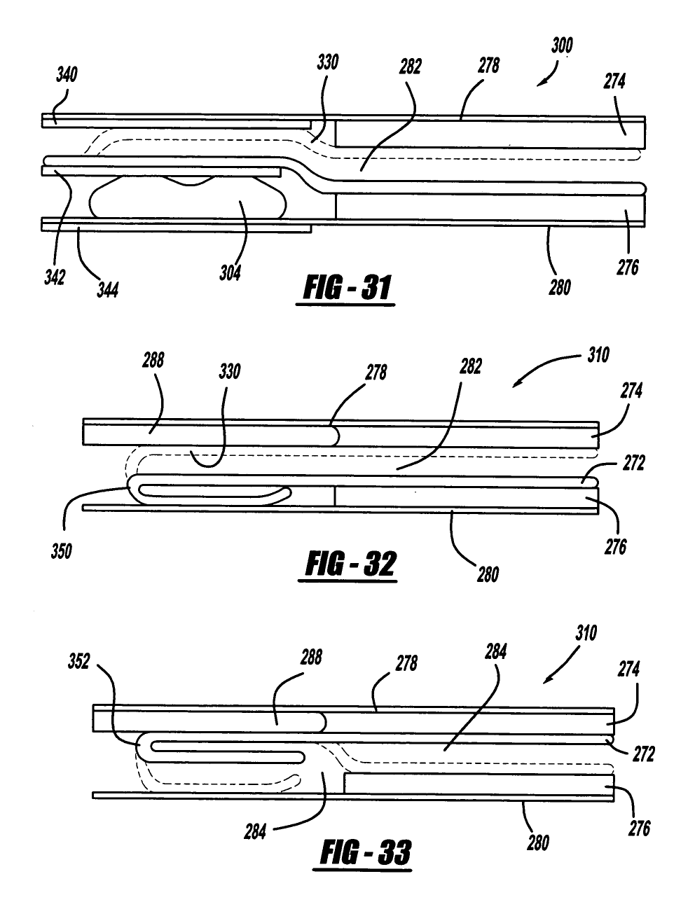

FIG. 29 is a cross-sectional view of a fuel cell structure 320 in the fuel cell stack 182 through line 25-25 for a different sealing design, where like elements to the fuel cell structure 270 are identified by the same reference numeral, according to another embodiment of the present invention. In this embodiment, the diffusion media layers 274 and 276 have been shortened and the plate 272 has a double folded edge portion 322 that provides the seal at the seal area 186. The folded edges may create a void region that contains reactant gas that is connected to the channels on the bottom of the plate 272. This void volume can be reduced with the folded portion 322. While other edge configurations are possible, some of what is shown here is limited to the configurations that would support functional tunnel configurations. The folded edge portions will require different approaches for cell voltage tabs, cell-to-cell shorting tabs and alignment pins. The double folded edge portion 322 could accommodate these features and could be used only along the edges where these features are required with a transition from single to double folds in the anode headers.

The sealing method used at the edges needs to be consistent with the configuration at the tunnels. The challenge becomes maintaining seal support on one side, while creating gas passages on the other side of the plate. For a bipolar plate with two plate halves, this is accomplished by forming holes or tunnels on one plate half to allow a reactant gas to pass where the other plate half is smooth for sealing against the membrane. Use of diffusion media layers or shims to provide a smooth surface across the tunnels found in the plate are considered as well as folded edges to create two independent surfaces from the single plate.

FIG. 30 is a cross-sectional view of the fuel cell structure 270 through line 30-30 of the stack 182 in the tunnel region between the cathode outlet manifold 192 and the active area 184. A cathode land feature 330 is shown in silhouette, where a fill material 332 is provided at the back side of the tunnel that forms the cathode flow channels 282 through the tunnel region between the anode inlet header 196 and the active area 184.

FIG. 31 is a cross-sectional view of the fuel cell structure 300 through line 30-30 of the stack 182 in the tunnel region between the cathode outlet header 192 and the active area 184. In this embodiment, the seal 302 has been eliminated to provide the tunnel through which the cathode reactant gas can flow through the flow channel 282. Shims 340, 342 and 344 are provided as shown to provide stiffness across the tunnels in the seal area 186. The shims 340, 342 and 344 are needed on both sides of the plate 272 to provide a smooth surface on both sides of the seal. The shim on the non-flow side of the tunnels also must be bonded to the plate 272 to block from passing on the tunnels to the wrong side of the plate 272. The shims 340, 342 and 344 may continue around the perimeter of the membrane as a sub-gasket, although they are not shown in FIG. 26. These additional components and associated assembly processes make this approach even less attractive.

FIG. 32 is a cross-sectional view of the fuel cell structure 310 through line 30-30 of the stack 182 in the tunnel region between the cathode outlet header 192 and the active area 184. In this embodiment, the folded edge portion 312 is replaced with a folded edge portion 350 to accommodate the tunnel through which the cathode reactant gas flows.

FIG. 33 is a cross-sectional view of the fuel cell structure 310 through line 33-33 of the stack 182 in the tunnel region between the anode inlet header 196 and the active area 184. In this embodiment, the folded edge portion 312 is replaced with a folded portion 352 to accommodate the tunnel through which the anode reactant gas flows. With only a single extended diffusion media layer or shim, it may be necessary to bond the membrane to the diffusion media layer or shim, respectively, so that the membrane does not lift creating a leakage path to the wrong side of a plate. If the bonding cannot be achieved, shims could be used on both sides of the membrane.

Tunnels are shown from both sides of the plate with respect to the folded edge. Since reactant gas occupies the void formed by the folded edge, it is necessary to fold in the same direction on all edges of the plate, otherwise the fold would create a leakage path between the two reactant gases. If the ends of the folds could be sealed, then this requirement could be avoided. The diffusion media layer or shim could extend to the edge only in their region of the tunnels, however, this creates a lack of seal load support in the transition from the diffusion media layer or shim surface to folded plate surfaces. It is noted that filling the diffusion media layer over the tunnels is not required as the reactant gas flow is flowing through the tunnels in this location anyway.

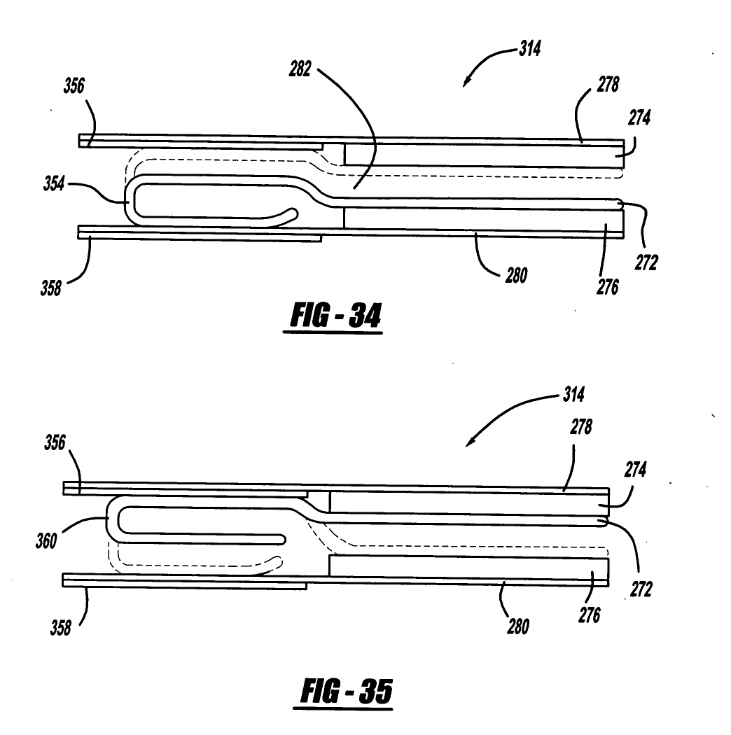

FIG. 34 is a cross-sectional view of the fuel cell structure 314 through line 30-30 of the stack 182 in the tunnel region between the cathode outlet header 192 and the active area 184. In this embodiment, the folded edge portion 316 is replaced with a folded edge portion 354 to accommodate the tunnel through which the cathode reactant gas flows. Shims 356 and 358 provide stiffness across the tunnel regions. The shim function is preferably provided by membrane sub-gaskets, which would continue around the perimeter of the membrane, although not shown in FIG. 28.

FIG. 35 is a cross-sectional view of the fuel cell structure 314 through line 33-33 of the stack 182 in the tunnel region between the anode inlet header 192 and the active area 184. In this embodiment, the folded edge portion 316 is replaced with a folded edge portion 360 to accommodate the tunnel through which the anode reactant gas flows.

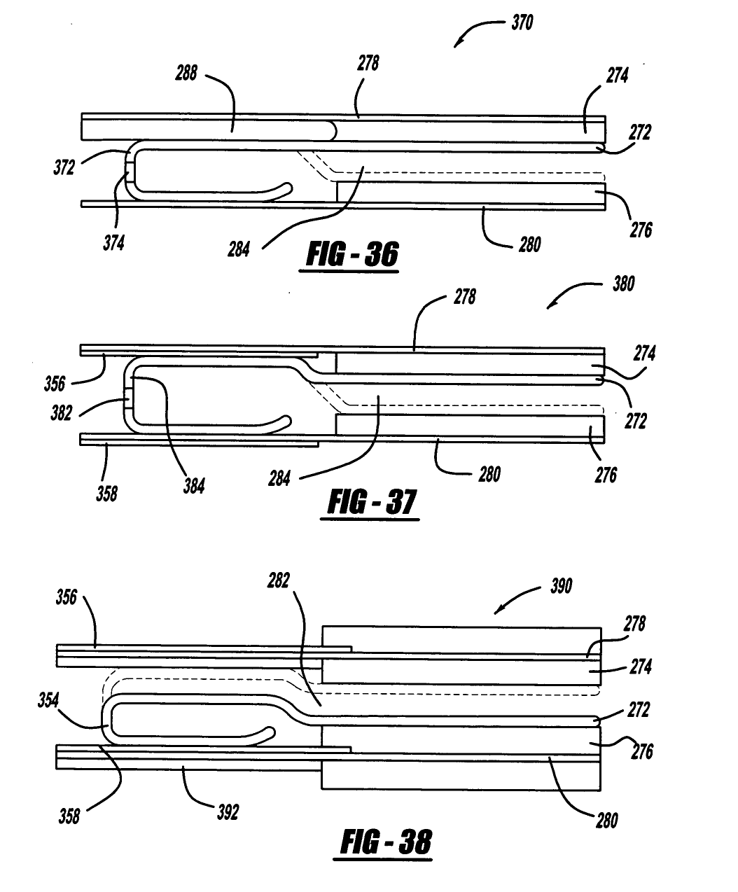

FIG. 36 is a cross-sectional view of a fuel cell structure 370 similar to the fuel cell structure 310 shown in FIG. 33 through the seal area 186 at line 33-33, where like elements are identified by the same reference numeral, according to another embodiment of the present invention. In this embodiment, the folded edge portion 352 of the plate 272 is replaced with a widened folded edge portion 372 having an opening 374 through which the hydrogen reactant gas enters the active area 184 from the header 196. Due to the interconnection of the voids formed by the fold, only one reactant gas can be fed in this way. Given the need for wicking across the cathode plate, this structure could only be used for the anode side. This also adds additional process steps to form the holes in the plate.

FIG. 37 is a cross-sectional view of a fuel cell structure 380 similar to the fuel cell structure 314 shown in FIG. 35 through line 33-33 of the stack 182 in the tunnel region between the anode inlet header 192 and the active area 184, where like elements are identified by the same reference numeral, according to another embodiment of the present invention. The folded edge portion 360 has been extended to cover the entire seal area. In this embodiment, an opening 382 is formed in the folded edge portion 384 through which the hydrogen reactant gas flows.

The corners become the junction of two edges. For the fill configurations, it does not present an issue as the same configuration as the edge can be continued around the corner. For the folded configurations, the plate 272 cannot be folded around a corner. At this location, it becomes apparent that the fold direction cannot be changed without severing the plate. A sophisticated process to rejoin the severed edges and filling the void could be used. The key for a simplified folded edge configuration is to maintain one surface smooth so that the seal to the membrane on one side can be maintained. On the other side, where the plate 272 is folded under, gaps are allowed as the corner is covered by an external header. Of course, the external header must correspond to the reactant gas within the void created by the folded edge. It is also noted that the folded edges create a bi-pass channel between the inlet and outlet headers. A film material could be inserted into this fold to reduce this by-pass.

FIG. 38 is a cross-sectional view of a fuel cell structure 390 through line 30-30 of the stack 182 in the tunnel region between the cathode outlet header 192 and the active area 184. In this embodiment, a thicker shim 392 provides stiffness across the tunnel region. To avoid excess local compression, the thicker shim 392 does not go under the diffusion media layer 274. Shims 356, 358 and 392 also function as membrane sub-gaskets and continue around the perimeter, although not shown in FIG. 28. This is similar to the configuration shown in FIG. 34.

FIG. 39 is a top plan view of a corner area of the fuel cell stack 182 proximate the anode inlet header 196 and the cathode outlet header 192.

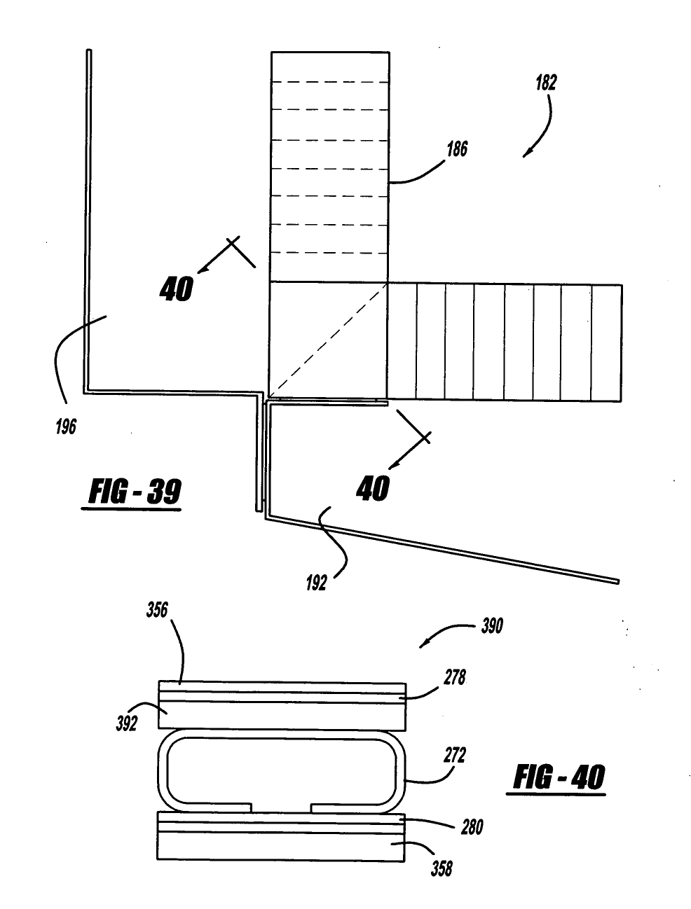

FIG. 40 is a cross-sectional view of the fuel cell structure 390 through line 4040 in FIG. 39.

Several edge and tunnel options have been described herein. Some configurations should have lower material costs and fewer processing steps while meeting the functional requirements. The filled configuration will have higher costs due to the processing time to cure the filling material. The approach of using the diffusion media layers as a seal support is advantageous, as this does not require an additional part. Using a sub-gasket as a shim has the same advantage. Thus, either the edge configuration shown in FIG. 27 with the tunnel configuration in FIGS. 32 and 33, or the edge configuration shown in FIG. 28 with the tunnel configuration in FIGS. 34 and 35 are suitable. Although using a diffusion media layer as a seal support requires an additional step to fill the edge, this could be done as a continuous hot press process as only a strip along each of the anode header sides of the diffusion media layer need to be filled if the cathode diffusion media layer is used as a seal support as the fold is towards the anode side.

It is also recommended that the diffusion media layer be used around the entire perimeter, and not just in the tunnel region due to the leakage potential. If shims are used, the preferred approach is to use a thick sub-gasket to provide this function. Shim support instead of diffusion media layer support allows more space for forming the folded edge and tunnels, which may be helpful given the small dimensions, and also allows more spring range of the folded seal. One issue with this configuration is that the sub-gaskets typically extend onto the diffusion media layer, so this would create high compression loads in the overlap region. It is also important not to leave a gap between the diffusion media layer and the sub-gasket, or to have catalysts not covered by the diffusion media layer. To address this, an approach is recommended to simultaneously cut with the same die cutter both the diffusion media layer and the thick sub-gasket so that the diffusion media layer fits perfectly into the hole formed in the thick sub-gasket frame. A thin sub-gasket on the diffusion media layer could also be used on the other side with a smaller window, which would typically be the anode. Since this does not require any additional parts or processes other than folding the edges, this design provides certain advantages. The use of holes in the edge for tunnels as shown in FIGS. 36 and 37 does not provide any advantages over stamped tunnels, but requires additional processing.

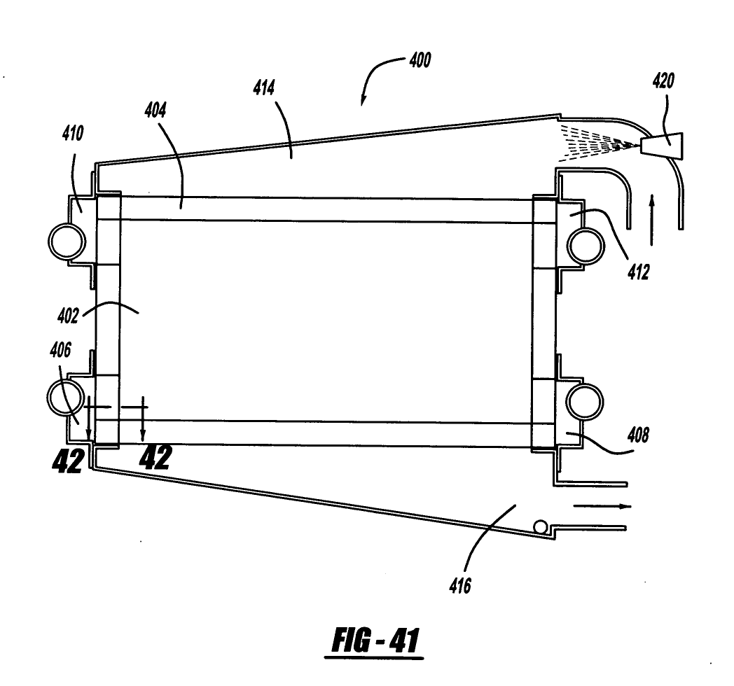

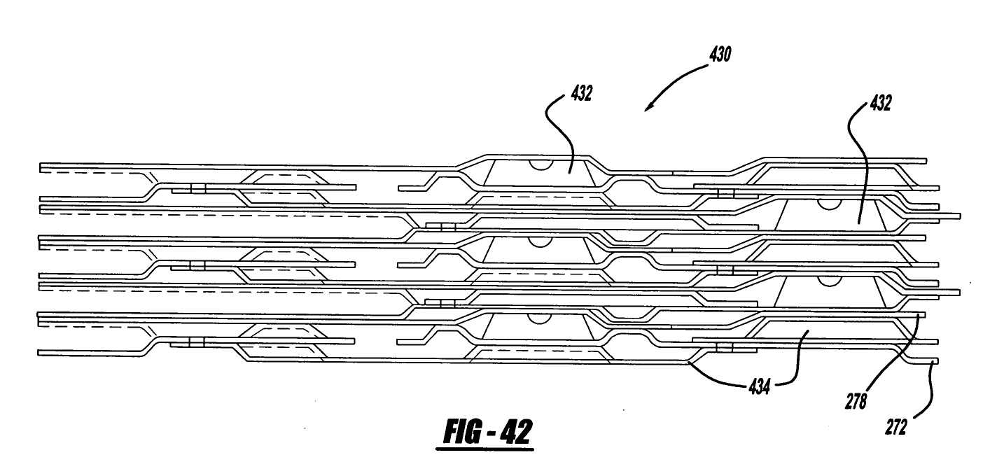

An alternate method for introducing evaporative cooling water includes using an atomizer that sprays water into the cathode airline. FIG. 41 is a top plan view of a fuel cell stack 400 including an active area 402, according to another embodiment of the present invention. A seal area 404 is defined around the active area 402. Anode reactant gas is sent to the active area 402 through anode inlet headers 406 and 408 and exit the stack 400 through anode exhaust gas headers 410 and 412, respectively. Further, cathode inlet air is then sent to the stack 400 through cathode inlet header 414 and is output from the stack 400 through cathode outlet header 416. In this design, a water atomizer 420 adds water to the cathode inlet air in the cathode inlet header 414 for evaporative cooling purposes.

In this diagram, the orientation is shown such that flow or water spray distributions along the header flow direction will be within cells and not cell-to-cell. Multiple atomizers and cathode lines could be used to achieve the required turn-down or to adjust for flow distribution. Note that a large evaporative water turn-down is not required as excess water would be recycled.

Analysis of the condenser size needed for this operational approach has been determined to be about 20% larger than the radiator for a conventional operated fuel cell. This would be an issue for conventional vehicle packaging. Considering most vehicle drive cycles, a water buffer collector under low power operation could be used to provide the needed water under periods of high power operation. However, some vehicles need to provide continuous high power operation, such as for towing applications. It is also recognized that an air-cooled condenser would be unsuitable for sub-zero operation. To isolate the condenser from sub-zero conditions, a water-glycol loop could be used between an air cooler radiator and a water-glycol cooled condenser. It may also be necessary to construct the condenser from stainless steel or other corrosion resistant materials.

FIG. 42 is a cross-sectional view through line 42-42 of a fuel cell structure 430 of the stack 400 showing the tunnel configuration between the anode inlet header 406 and the active area 402. The fuel cell structure 430 includes staggered seals 432 and inserts 434.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell stack including a plurality of stacked fuel cells, each fuel cell including an active area, said fuel cell stack comprising:
a plurality of membranes where each fuel cell in the stack includes a membrane;
a plurality of diffusion media layers where each fuel cell includes an anode side diffusion media layer at an anode side of the fuel cell and a cathode side diffusion media layer at a cathode side of the fuel cell;
a plurality of bipolar plates positioned between the fuel cells in the stack adjacent to the diffusion media layers, said bipolar plates including anode flow channels facing the anode side diffusion media layer and cathode flow channels facing the cathode side diffusion media layer;
an anode inlet header directing an anode reactant gas flow to the anode flow channels;
an anode outlet header receiving the reactant gas flow from the anode flow channels;
a cathode inlet header directing a cathode reactant gas flow to the cathode flow channels;
a cathode outlet header receiving the cathode reactant gas flow from the cathode flow channels; and
seals provided around the active area of the fuel cells and between the active area and the headers, said seals being formed by folding an edge of the bipolar plate.

2. The stack according to claim 1 wherein each bipolar plate includes an anode side uni-polar plate and a cathode side uni-polar plate.

3. The stack according to claim 2 wherein the edges of both the anode side plate and the cathode side plate are folded to provide the seal.

4. The stack according to claim 2 wherein only the edge of the anode side plate is folded to provide the seal.

5. The stack according to claim 2 wherein only the edge of the cathode side plate is folded to provide the seal.

6. The stack according to claim 2 wherein only the edge of the anode side plate is folded to provide a tunnel for the anode gas reactant gas flow between the anode inlet header and the active region and the anode outlet header and the active region.

7. The stack according to claim 2 wherein only the edge of the cathode side plate is folded to provide a tunnel for the cathode gas reactant flow between the cathode inlet header and the active area and the cathode outlet header and the active area.

8. The stack according to claim 2 further comprising a cooling fluid inlet header directing a cooling fluid to cooling fluid flow channels and a cooling fluid outlet header receiving the cooling fluid from the cooling fluid flow channels, said cathode side and anode side plates defining cooling fluid flow channels therebetween, wherein the edges of both the cathode side and anode side plates are folded to provide the seal and a tunnel between the cooling fluid inlet header and the active region and the cooling fluid outlet header and the active region.

9. The stack according to claim 2 further comprising shims at the seal to define the seal thickness.

10. The stack according to claim 2 wherein only the edge of one of the cathode side plate or the anode side plate is folded, and wherein the fold is a double fold.

11. The stack according to claim 10 wherein the double fold includes a tab that extends outside of the stack.

12. The stack according to claim 1 further comprising a cooling fluid inlet header directing a cooling fluid to cooling fluid flow channels and a cooling fluid outlet header receiving the cooling fluid from the cooling fluid flow channels, said cathode side and an anode side plates defining cooling fluid flow channels therebetween, wherein the edge of one or both the cathode side plate or the anode side plate is folded to provide the seal, and wherein the cooling fluid inlet header and the cooling fluid outlet header are positioned at corners of the active area to cover the corners and collect cooling fluid leaks.

13. The stack according to claim 1 further comprising corners covers at one or more of the corners of the active area to prevent leaks that might otherwise occur as a result of the folds.

14. The stack according to claim 1 wherein each bipolar plate is a single plate defining the cathode flow channels on one side of the plate and the anode flow channels on an opposite side of the plate.

15. The stack according to claim 14 wherein one or both of the diffusion media layers on either side of the bipolar plate extend across the seal area, and are filled with a fill material at the seal.

16. The stack according to claim 14 wherein the edge of the single plate is folded in a double fold.

17. The stack according to claim 14 wherein the edge of the single plate is folded in a manner to provide a tunnel between the anode inlet header and the anode flow channels, a tunnel between the anode outlet header and the anode flow channels, a tunnel between the cathode inlet header and the cathode flow channels and a tunnel between the cathode outlet header and the cathode flow channels.

18. The stack according to claim 14 further comprising shims at the seal to define the seal thickness.

19. The stack according to claim 14 wherein the folded edge of the single plate has a hole extending therethrough to provide flow between one of the headers and the flow channels.

20. A bipolar plate for a fuel cell, said bipolar plate comprising:
a cathode side uni-polar plate defining cathode flow channels; and
an anode side uni-polar plate defining anode flow channels, where cooling fluid flow channels are defined between the cathode side and anode side uni-polar plates, and wherein one or both of an edge of the cathode or anode side bipolar plates are folded over to define a seal at an edge of the fuel cell.

21. The bipolar plate according to claim 20 wherein only the edge of the anode side plate is folded to provide a tunnel for an anode gas reactant flow between an anode inlet header and a fuel cell active region and an anode outlet header and the fuel cell active region.

22. The bipolar plate according to claim 20 wherein only the edge of the cathode side plate is folded to provide a tunnel for a cathode gas reactant flow between a cathode inlet header and a fuel cell active area and a cathode outlet header and the fuel cell active area.

23. The bipolar plate according to claim 20 wherein the edges of both the cathode side and anode side plates are folded to provide the seal and a tunnel between a cooling fluid inlet header and a fuel cell active region and a cooling fluid outlet header and the fuel cell active region.

24. The bipolar plate according to claim 20 wherein only the edge of one of the cathode side plate or the anode side plate is folded, and wherein the fold is a double fold.

25. The bipolar plate according to claim 24 wherein the double fold includes an extending tab.

26. A bipolar plate for a fuel cell, said bipolar plate being a single plate and including anode flow channels on one side of the plate and cathode flow channels on an opposite side of the plate, wherein an edge of the bipolar plate is folded over to define a seal at an edge of the fuel cell.

27. The bipolar plate according to claim 26 wherein the edge of the plate is folded in a double fold.

28. The bipolar plate according to claim 26 wherein the edge of the plate is folded so as to provide a tunnel between an anode inlet header and the anode flow channels, a tunnel between an anode outlet header and the anode flow channels, a tunnel between a cathode inlet header and the cathode flow channels and a tunnel between a cathode outlet header and the cathode flow channels.

29. The bipolar plate according to claim 26 wherein the folded edge of the plate has a hole extending therethrough to provide flow between a header and the flow channels.
